(19) United States
(12) Patent Application Publication
(10) Pub. No.: US 2021/0028430 A1
(43) Pub. Date: Jan. 28, 2021

(54) Cell Connector for a Battery Module of a High-Voltage Battery of a Motor Vehicle, Battery Module, Motor Vehicle and Method for Producing a Battery Module

(71) Applicant: Bayerische Motoren Werke Aktiengesellschaft, Muenchen (DE)

(72) Inventors: Azad DARBANDI, Unterfoehring (DE); Juergen HEROLD, Furth im Wald (DE); Juergen HILDINGER, Hoehenkirchen-Siegertsbrunn (DE); Philipp SCHMIDT, Muenchen (DE); Hubertus WELSCH, Muenchen (DE)

(21) Appl. No.: 16/966,143

(22) PCT Filed: Feb. 20, 2019
(86) PCT No.: PCT/EP2019/054139

§ 371 Date: Jul. 30, 2020

(30) Foreign Application Priority Data
Mar. 22, 2018 (DE) 10 2018 204 373.6

(51) Int. Cl. H01M 2/20; H01M 2/10

(52) U.S. Cl. CPC H01M 2/206; H01M 2220/20; H01M 2/1077

(57) ABSTRACT

A cell connector for a battery module of a motor vehicle for electrically connecting cell poles of at least two battery cells which are stacked in a stacking direction to form a cell block is designed as an L-profile-shaped, slotted angled strip which can be arranged on an edge that is formed between a top side and a side region of the cell block. The angled strip has a first angle region, which is oriented parallel in relation to the top side and a second angle region, which is oriented parallel in relation to the side region. The first angle region has at least two strip-like contact elements for making contact with the cell poles, and the second angle region has a strip-like connecting element for connecting the contact elements.

### BACKGROUND AND SUMMARY OF THE INVENTION

The invention relates to a cell connector for a battery module of a high-voltage battery of a motor vehicle for electrically connecting cell poles of at least two battery cells which are stacked in a stacking direction to form a cell block. The invention also relates to a battery module, to a motor vehicle and to a method for producing a battery module.

At present, interest is directed at high-voltage batteries or high-voltage energy stores for electrically driveable motor vehicles, for example electric vehicles or hybrid vehicles. Motor vehicles of this kind usually have, in the drive train, an electrical machine or an electric motor for driving the motor vehicle and the high-voltage battery which provides electrical energy for the electrical machine. High-voltage batteries usually comprise a large number of battery modules, wherein each battery module has a cell block comprising a large number of battery cells, which are stacked one behind the other for example. In this case, the battery cells are interconnected in series and/or in parallel with one another within a cell block by way of the corresponding cell poles of adjacent battery cells being electrically connected by means of cell connectors. During operation of the battery, the volumes of these battery cells can change, for example depending on their respective state of charge, and therefore the relative position of the cell poles of two adjacent battery cells changes.

In order to nevertheless provide reliable and long-term contact-connection of the cell poles, the prior art, for example DE 10 2006 015 566 A1, discloses designing the cell connector such that the length is variable. To this end, the cell connector can be of arcuate design and be arranged on the top sides, which comprise the cell poles, of the battery cells. However, an arcuate cell connector of this kind has a negative effect on a z-dimension of the high-voltage battery. That is to say a height of the battery module and therefore a height of the high-voltage battery are increased by the cell connectors, and therefore the high-voltage battery has a high space requirement in the motor vehicle. EP 2 819 217 A1 discloses a battery system comprising a cell connector which is arranged to the sides of the battery system at least in regions. The cell connector is produced by way of a first section composed of aluminum and a second section composed of copper being joined to one another by an electromagnetic powder welding process in a cell connector joining area. A cell connector of this kind is complicated to manufacture and is highly susceptible to corrosion, in particular at the joining area.

The object of the present invention is to provide a cell connector, which is particularly simple to manufacture and has a long service life, for a battery module of a high-voltage battery of a motor vehicle.

According to the invention, this object is achieved by a cell connector, a battery module, a motor vehicle and a method having the features according to the respective independent patent claims. Advantageous embodiments of the invention are the subject matter of the dependent patent claims, the description and the figures.

A cell connector according to the invention for a battery module of a high-voltage battery of a motor vehicle serves for electrically connecting cell poles of at least two battery cells which are stacked in a stacking direction to form a cell block. The cell connector is designed as a one-part, L-profile-shaped angled strip which is slotted perpendicular to the stacking direction in regions, which angled strip can be arranged on an edge which extends in the stacking direction and is formed between a top side, which comprises the cell poles, and a side region of the cell block. The cell connector has a first angled region, which is oriented parallel to a first plane which corresponds to the top side, and a second angled region, which is oriented parallel to a second plane which corresponds to the side region. The first angled region has at least two strip-like contact elements, which are separated by a slot, for contact-connecting the cell poles of the battery cells. The second angled region has a strip-like connecting element for electrically and mechanically connecting the strip-like contact elements.

The cell connector is provided, in particular, for a high-voltage battery which can comprise a plurality of battery modules. This high-voltage battery can be, for example, a traction battery which provides electrical energy for a drive of a motor vehicle which is designed as an electric vehicle or hybrid vehicle. The battery modules of the high-voltage battery can be arranged in a battery housing and can be interconnected to one another there. In this case, the battery modules each have a cell block with a predetermined number of battery cells. In this case, the battery cells are, in particular, prismatic battery cells which are each in the form of a flat cuboid. The battery cells each have a bottom side and a top side which is situated opposite the bottom side in a vertical direction. The cell poles or cell terminals of the battery cell, a negative pole and a positive pole, are arranged on the top side of the battery cell. In addition, the battery cells each have a front side and a rear side and two opposite side regions. In this case, the battery cells are stacked in the stacking direction by way of the front side of one battery cell being arranged in a manner adjoining the rear side of a battery cell which precedes it in the cell block. Therefore, the stacking direction corresponds to a depth direction of the battery cells. In this case, the stacked battery cells can be arranged in a frame for compressing the battery cells.

The cell block is formed in a cuboidal manner by the stacked, prismatic battery cells. In this case, the top side of the cell block is formed by the top sides of the battery cells. A bottom side of the cell block is formed by the bottom sides of the battery cells. The side regions of the cell block are formed by the side regions of the battery cells. A front side of the cell block is formed by the front side of the battery cell of the cell block that is first in the stacking direction and the rear side of the cell block is formed by the rear side of the battery cell of the cell block that is last in the stacking direction. In this case, the cell poles of the battery cells extend on the top side of the cell block in the stacking direction parallel to the two opposite edges which are formed between the two opposite side regions and the top side of the cell block.

The slotted angled strip is used for electrically connecting the cell poles of at least two adjacent battery cells. The slotted angled strip is preferably, in particular completely, formed from aluminum. The angled strip is of one-part or one-piece design. This means that the angled strip does not have any joints, but rather is formed from one piece. The angled strip has the first, planar angled region for arrangement parallel to the top side of the cell block and the second, planar angled region for arrangement parallel to one of the side regions of the cell block. In this case, the first plane of the first angled region is formed, in particular, perpendicularly to the second plane of the second angled region. The two angled regions therefore form an angled strip with an L-shaped profile.

In this case, the first angled region is provided with at least one slot which extends perpendicularly to the stacking direction and parallel to that of the top side of the cell block in the state in which the cell connector is arranged on the cell block. The slot separates two sections of the first angled region from one another, so that the two strip-like, flat contact elements are produced. In this case, a length and a width of the contact elements are considerably larger than a thickness of the contact elements. The contact elements have, in particular, the same dimensions. In this case, these strip-like contact elements are connected on one side to the likewise flat, strip-like connecting element which is located in the second angled region. The first, slotted angled region and the second angled region therefore form an angled comb structure. Owing to the at least one slot between the contact elements, the angled strip is designed to be flexible or movable in the stacking direction. When the cell poles move, the contact elements can be moved with them without being destroyed.

In order to electrically connect the battery cells, the angled strip can be arranged on the respective edge of the cell block in such a way that the respective contact element of the first angled region rests on the associated cell pole on the top side of the cell block. The strip-like contact element therefore extends, starting from the edge, in a width direction, which is oriented perpendicularly to the stacking direction, of the battery cell over the top side of the battery cell and in so doing covers the respective cell pole, in particular completely. The second angled region bears against the side region of the cell block or against the frame which surrounds the cell block, wherein the connecting element extends in a strip-like manner along the stacking direction. In order to fasten the angled strip to the cell block, the contact elements can be welded to the respective cell pole.

A cell connector in the form of the slotted angled strip is particularly simple and cost-effective to produce. To this end, for example, a flat, rectangular metal plate, for example an aluminum plate, can be bent, so that an L-profile-shaped angled strip is initially produced. This angled strip can then be provided with the number of slots required for the number of contact elements at least in the first angled region. Since the cell connector is of one-piece design, there are no joints which are susceptible to corrosion. A battery module comprising a cell connector of this kind therefore has a small z-dimension, wherein the cell connector contact-connects the battery cells in a reliable manner with a long service life at the same time.

Provision can be made for the first angled region to have at least three strip-like contact elements, which are separated by a respective slot, for contact-connecting the cell poles of at least three battery cells. For example, it may be the case that at least three battery cells which are stacked one behind the other are to be connected in parallel. In this case, the battery cells are arranged in the cell block in such a way that identical cell poles are arranged one behind the other in the stacking direction. In this case, a cell connector, which has at least a number of contact elements which corresponds to the number of battery cells to be connected in parallel, is arranged on each edge. In the event that all battery cells are intended to be connected in parallel in one cell block, the angled strip extends over an entire depth of the cell block. In the event that battery cells or parallel circuits of battery cells are intended to be connected in series, two adjacent battery cells are arranged in such a way that cell poles of different kinds are arranged one behind the other in the stacking direction and are electrically connected to one another by means of the contact areas of a cell connector.

It has proven advantageous when a width of the slot that extends in the stacking direction is less than a width of a strip-like contact element, in particular in that the width of the slot corresponds at most to 30% of the width of a strip-like contact element. The contact elements therefore have an area which is larger than an area of the slot, so that stable contact elements which provide reliable contact-connection of the cell poles are provided.

In a development of the invention, a slot, which is arranged between two contact elements, is designed to extend into the second angled region in regions. The comb structure is therefore angled away in the region of the comb tines which form the contact elements. The at least one slot therefore extends over an edge of the angled strip into the second angled region as far as the strip-like connecting element. Provision is made, in particular, for a width of the connecting element perpendicular to the stacking direction to be greater than a length of the portion of the slot that protrudes into the second angled region. The angled strip is therefore of particularly stable design on the one hand, but on the other hand allows movement of the cell poles along the stacking direction without loss of contact.

The angled strip particularly preferably has a third angled region which is oriented parallel to a third plane, which corresponds to a front side or rear side of the cell block, and which is designed as a strip-like module connection element, for example for electrically connecting at least two battery modules. The first plane, the second plane and the third plane of the angled strip are oriented, in particular, perpendicularly to one another. In the state in which the angled strip is arranged on the respective edge of the cell block, the third angled region is arranged parallel to the front side of the cell block or parallel to the rear side of the cell block. For example, the third angled region can be arranged directly on the front side or rear side of the cell block or on the frame which covers the front side or rear side of the cell block. The third angled region forms a module connection or current tap of the battery module. The battery modules can be interconnected to one another by means of the respective third angled regions of two battery modules. Since the third angled region is arranged on the front side or rear side, a z-dimension of the battery module is not negatively influenced by the module connection either. A high-voltage battery, the battery modules of which are electrically connected by means of cell connectors of this kind, therefore requires a comparatively small installation space.

The strip-like module connection element is preferably designed as an angled-away end section of the strip-like connecting element of the second angled region. The end section of the connecting element is therefore angled away in the region of a corner edge which is formed between the front side or rear side and a side region of the cell block. The connecting element in the second angled region therefore extends, starting from the corner edge, along the stacking direction, while the strip-like module connection element extends, starting from this corner edge, in the width direction of the cell block. A cell connector comprising a module connection of this kind can likewise be manufactured in a particularly simple manner.

The invention also relates to a battery module for a high-voltage battery of a motor vehicle comprising at least two battery cells which are stacked in a stacking direction to form a cell block, which cell block has two opposite edges which extend in the stacking direction, wherein at least one cell connector is arranged on a respective edge. Depending on the interconnection of the battery cells within the battery module, a plurality of DC-isolated cell connectors, which can also differ in terms of the number of contact elements, can also be arranged one behind the other in the stacking direction on each edge of the cell block. In this case, a respective cell connector comprising a module connection can also be arranged on each edge.

Therefore, in order to produce a battery module of this kind, an interconnection of the battery cells within the battery module is prespecified, a number of cell connectors, which corresponds to the prespecified interconnection, and a number of contact elements, which corresponds to the interconnection, of the respective cell connector are determined and a mounting device is fitted with the cell connectors. The mounting device is arranged on the cell block in such a way that the cell connectors are arranged on the edges. The contact elements are then welded to the cell poles and the mounting device is removed. The mounting device can be, for example, a plastic frame which is filled with the corresponding cell connectors. This frame can then be arranged on the cell block, and therefore the contact elements of the cell connectors are positioned on the associated cell poles. The cell poles and the contact elements can then be welded in a simple manner there. The battery module can therefore be produced in a small number of production steps.

A motor vehicle according to the invention comprises a high-voltage battery comprising at least one battery module according to the invention. The motor vehicle is, in particular, a passenger car in the form of an electric or hybrid vehicle.

The embodiments presented with reference to the cell connector according to the invention and the advantages of the embodiments correspondingly apply to the battery module according to the invention, the motor vehicle according to the invention and the method according to the invention.

Further features of the invention can be gathered from the claims, the figures and the description of the figures. The features and combinations of features mentioned above in the description and the features and combinations of features mentioned below in the description of the figures and/or shown in the figures alone can be used not only in the respectively indicated combination but also in other combinations or on their own.

The invention will now be explained in more detail using a preferred exemplary embodiment and with reference to the drawings.

### BRIEF DESCRIPTION OF THE DRAWINGS

FIG. 1 is a schematic perspective view of an embodiment of a battery module according to the invention.

FIG. 2 is a plan view of the battery module.

FIG. 3 is a side view of the battery module.

FIG. 4 is a front view of the battery module.

Identical or functionally identical elements are provided with the same reference signs in the figures.

### DETAILED DESCRIPTION OF THE DRAWINGS

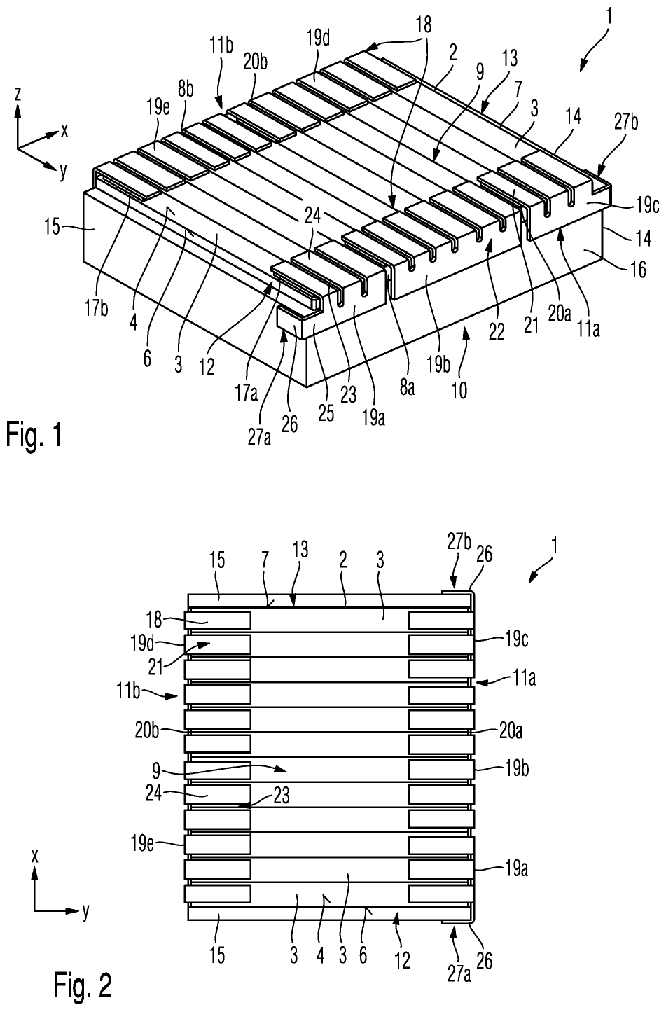

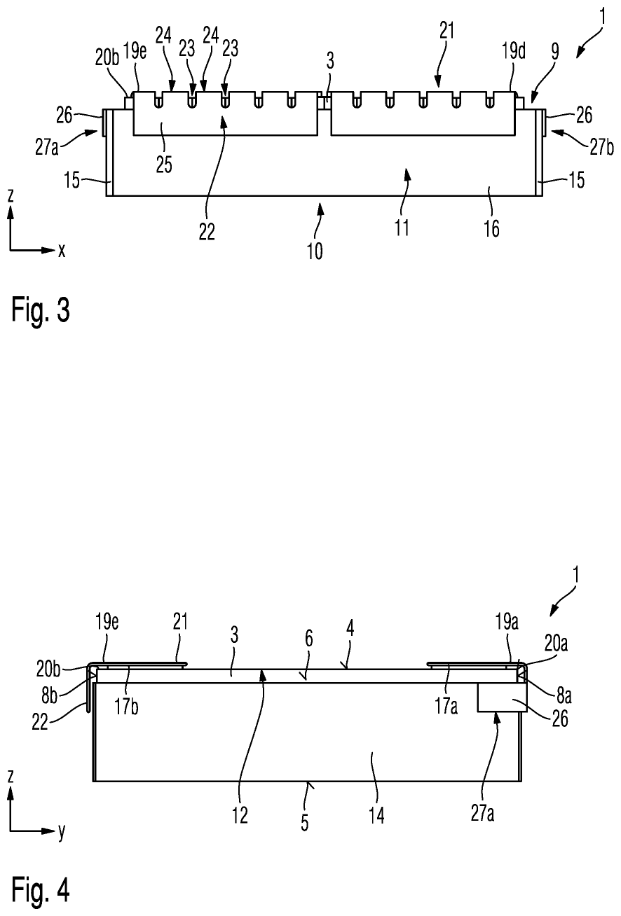

FIG. 1, FIG. 2, FIG. 3 and FIG. 4 show different views of a battery module 1 for a high-voltage battery (not shown). The high-voltage battery can be a traction battery of a motor vehicle (not shown), and provide electrical drive energy for an electrical drive machine of the motor vehicle. The battery module 1 has a cell block 2 which here has twelve battery cells 3 which are stacked one behind the other in a stacking direction x. The battery cells 3 are designed as prismatic battery cells and are in the form of a flat cuboid. Each of the battery cells 3 has a top side 4, a bottom side 5 (see FIG. 4), a front side 6, a rear side 7 and side regions 8a, 8b.

A top side 9 of the cell block 2 is formed by the top sides 4 of the stacked battery cells 3 and a bottom side 10 of the cell block 2 is formed by the bottom sides 5 of the battery cells 3. Side regions 11a, 11b of the cell block 2 which are situated opposite one another are formed by the side regions 8a, 8b of the battery cells 3, which side regions are situated opposite one another. A front side 12 of the cell block 2 is formed by the front side 6 of a battery cell 3 which is arranged first in the stacking direction x and a rear side 13 of the cell block 2 is formed by the rear side 7 of a battery cell 3 which is arranged last in the stacking direction x. The cell block 2 is therefore of cuboidal design. Here, the cell block 2 is arranged in a frame 14 which has a pressure plate 15 which is arranged on the front side 12 of the cell block 2 and a pressure plate 15 which is arranged on the rear side 13 of the cell block 2. Tie rods 16 of the frame 14, which tie rods press the pressure plates 15 and therefore the battery cells 3 together, extend along both side regions 11a, 11b of the cell block 2.

On their top side 4, the respective battery cells 3 have cell poles 17a, 17b or cell terminals. The cell poles 17a are, for example, positive poles of the battery cells 3 and the cell poles 17b are, for example, negative poles of the battery cells 3. The battery module 1 has a plurality of cell connectors 18 for electrically connecting the cell poles 17a, 17b of adjacent battery cells 3. The cell connectors 18 are designed as one-part, L-profile-shaped angled strips 19a, 19b, 19c, 19d, 19e which are slotted in regions. The slotted angled strips 19a, 19b, 19c, 19d, 19e consist, for example, of aluminum. In this case, the angled strips 19a, 19b, 19c, 19d, 19e are arranged on a respective edge 20a, 20b, which edge extends in the stacking direction x, of the cell block 2. In this case, a first edge 20a of the cell block 2 is formed between the top side 9 of the cell block 2 and a first side region 11a of the cell block 2 and a second edge 20b of the cell block 2 is formed between the top side 9 of the cell block 2 and a second side region 11b of the cell block 2. In this case, the angled strips 19a, 19b, 19c are arranged on the first edge 20a and the angled strips 19d, 19e are arranged on the second edge 20b.

Each of the angled strips 19a, 19b, 19c, 19d, 19e has a first angled region 21, which extends parallel to the top side 9 of the cell block 2, and a second angled region 22, which extends parallel to the respective side region 11a, 11b. In this case, the first angled region 21 is placed on the top side 9, which comprises the cell poles 17a, 17b, of the cell block 2. Here, the second angled region 22 is arranged so as to bear against the respective tie rod 16 which covers the side regions 11a, 11b of the cell block 2. The first angled region 21 is slotted perpendicular to the stacking direction x in a width direction y. The first angled region 21 therefore has at least one slot 23 which here extends into the second angled region 22 in regions. Here, each angled region 21 has at least two slots 23 which are spaced apart from one another in the stacking direction x.

The first angled region 21 is subdivided into strip-like contact elements 24, which can be welded to the respective cell poles 17a, 17b, by the slots 23. The strip-like contact elements 24 have, in particular, the same dimensions. The strip-like contact elements 24 extend over the respective edge 20a, 20b along the width direction y and are electrically and mechanically connected to one another by means of a strip-like connecting element 25 in the second angled region 22. The strip-like connecting element 25 extends in the stacking direction x. Owing to the slots 23 between the contact elements 24, the angled strip 19a, 19b, 19c, 19d, 19e is of flexible design along the stacking direction x. As a result, the contact elements 24 can also move when the volumes of the battery cells 3 are changed during operation of the high-voltage battery and therefore cause movement of the cell poles 17a, 17b. Owing to the configuration of the cell connectors 18 as one-part angled strips 19a, 19b, 19c, 19d, 19e, the electrical contact-connection of the battery cells 3 takes place by means of the side regions 11a, 11b of the cell block 2 in regions. As a result, the battery module 1 has particularly small dimensions in the vertical direction z.

In the present case, in each case three battery cells 3 are connected in parallel within the battery module 1, wherein the resulting four parallel circuits are interconnected to one another in series. The three front battery cells 3 are connected in parallel by means of the angled strips 19a, 19e (first parallel circuit), the three following battery cells 3 are connected in parallel by means of the angled strips 19b, 19e (second parallel circuit), the three further battery cells 3 are connected in parallel by means of the angled strips 19b, 19d (third parallel circuit) and the three rear battery cells 3 are connected in parallel by means of the angled strips 19c, 19d (fourth parallel circuit). The first and the second parallel circuit are interconnected to one another in series by means of the angled strip 19e, the second and the third parallel circuit are interconnected to one another in series by means of the angled strip 19b, and the third and the fourth parallel circuit are interconnected to one another in series by means of the angled strip 19d.

In addition, the angled strips 19a and 19c each have a third angled region 26, which forms module connections 27a, 27b of the battery module 1, here. A plurality of battery modules 1 can be interconnected to one another by means of the module connections 27a, 27b. The strip-like module connection 27a is oriented parallel to the front side 12 of the cell block 2 and here bears against the pressure plate 15 which is arranged on the front side. Here, the module connection 27a forms a positive current tap (HV+) of the battery module 1. The strip-like module connection 27b is formed parallel to the rear side 13 of the cell block and here bears against the pressure plate 15 which is arranged on the rear side. Here, the module connection 27b forms a negative current tap (HV−) of the battery module 1. The strip-like module connections 27a, 27b are designed, in particular, as angled-away end sections of the strip-like connecting element 25 of the second angled region 22.

Any desired interconnection of the battery cells 3 within the battery module 1 can be realized in this case. The corresponding angled strips 19a to 19e can then be selected depending on the interconnection and can be arranged in a mounting device, for example a plastic frame. This mounting device can then be positioned on the cell block 2 in such a way that the angled strips 19a to 19e are arranged on the corresponding edges 20a, 20b. The contact elements 24 which are arranged on the associated cell poles 17a, 17b can then be welded to the cell poles 17a, 17b and the mounting device can be removed.

### LIST OF REFERENCE SYMBOLS

1 Battery module
2 Cell block
3 Battery cell
4 Top side of the battery cell
5 Bottom side of the battery cell
6 Front side of the battery cell
7 Rear side of the battery cell
8a, 8b Side regions of the battery cells
9 Top side of the cell block
10 Bottom side of the cell block
11a, 11b Side regions of the cell block
12 Front side of the cell block
13 Rear side of the cell block
14 Frame
15 Pressure plate
16 Tie rod
17a, 17b Cell poles
18 Cell connector
19a, 19b, 19c, 19d, 19e Angled strips
20a, 20b Edges
21 First angled region
22 Second angled region
23 Slot
24 Contact element
25 Connecting element
26 Third angled region
27a, 27b Module connections
x, y, z Directions

1.-10. (canceled)

11. A cell connector for a battery module of a high-voltage battery of a motor vehicle for electrically connecting cell poles of at least two battery cells which are stacked in a stacking direction to form a cell block, comprising:
a one-part, L-profile-shaped angled strip which is slotted perpendicular to the stacking direction in regions, which angled strip is arrangeable on an edge which extends in the stacking direction and is formed between a top side, which comprises the cell poles, and a side region of the cell block, wherein
the angled strip has a first angled region, which is oriented parallel to a first plane which corresponds to the top side, and a second angled region, which is oriented parallel to a second plane which corresponds to the side region,
the first angled region has at least two strip-shaped contact elements, which are separated by a slot, for contact-connecting the cell poles of the battery cells, and
the second angled region has a strip-shaped connecting element for electrically and mechanically connecting the strip-like contact elements.

12. The cell connector according to claim 11, wherein
the angled strip with slots is formed from aluminum.

13. The cell connector according to claim 11, wherein
the first angled region has at least three strip-shaped contact elements, which are separated by a respective slot, for contact-connecting the cell poles of at least three battery cells. cm 14. The cell connector according to claim 11, wherein
a width of the slot that extends in the stacking direction is less than a width of a strip-shaped contact element.

15. The cell connector according to claim 11, wherein
the width of the slot corresponds at most to 30% of the width of a strip-shaped contact element.

16. The cell connector according to claim 11, wherein
a slot, which is arranged between two contact elements, is designed to extend into the second angled region in regions.

17. The cell connector according to claim 11, wherein
the angled strip has at least one third angled region which is oriented parallel to a third plane, which corresponds to a front side or rear side of the cell block, and which is designed as a strip-shaped module connection element.

18. The cell connector according to claim 17, wherein
the strip-shaped module connection element is designed as an angled-away end section of the strip-shaped connecting element of the second angled region.

19. A battery module for a high-voltage battery of a motor vehicle, comprising:
at least two battery cells which are stacked in a stacking direction to form a cell block, which cell block has two opposite edges which extend in the stacking direction; and
at least one cell connector according to claim 11 is arranged on a respective edge.

20. A motor vehicle comprising a high-voltage battery having at least one battery module according to claim 19.

21. A method for producing a battery module having: at least two battery cells which are stacked in a stacking direction to form a cell block, which cell block has two opposite edges which extend in the stacking direction; and having at least one cell connector arranged on a respective edge, the cell connector being a one-part, L-profile-shaped angled strip which is slotted perpendicular to the stacking direction in regions, which angled strip is arrangeable on an edge which extends in the stacking direction and is formed between a top side, which comprises cell poles, and a side region of the cell block, wherein
the method comprises the steps of:
prespecifying an interconnection of the battery cells, which are stacked to form the cell block, within the battery module;
determining a number of cell connectors, which corresponds to the prespecified interconnection, and a number of contact elements, which corresponds to the interconnection, of the respective cell connector;
fitting a mounting device with the cell connectors;
arranging the mounting device on the cell block such that the cell connectors are arranged on the edges;
welding the contact elements to the cell poles of the battery cells; and
removing the mounting device.
